(19) United States
(12) Patent Application Publication
(10) Pub. No.: US 2024/0257657 A1
(43) Pub. Date: Aug. 1, 2024

(54) SYSTEM AND METHOD FOR TRAINING INDIVIDUALS TO DEVELOP PROFESSION-RELEVANT SKILLS AND KNOWLEDGE THROUGH DECISION-MAKING EXERCISES

(71) Applicant: Sayed Nauman ABEDI, Hanover, MD (US)

(72) Inventor: Sayed Nauman ABEDI, Hanover, MD (US)

(21) Appl. No.: 18/444,519

(22) Filed: Feb. 16, 2024

Related U.S. Application Data
(60) Provisional application No. 63/448,467, filed on Feb. 27, 2023.

(51) Int. Cl. G09B 5/02

(52) U.S. Cl. CPC G09B 5/02

(57) ABSTRACT

The present invention relates to a system of decision-making instructional process (DMIP) that provides decision-making instructional exercises i.e., real project-based scenario exercises for training employees or individuals in their work roles. The system is applicable to a wide range of industries, corporations, and governments. The system uses past projects to create exercises that simulate decision-making and analytical processes associated with work roles. The training process involves selecting a project that is neither too complex nor too simple, creating scenarios from actual content, identifying information gaps, and collaborating with other individuals. The training is delivered through various mediums such as printed copies, video games, or virtual reality. The system provides a cost-effective and efficient way of training employees prior to their start date, resulting in increased learning and improved decision-making skills.

### FIELD OF THE INVENTION

The present disclosure relates generally to training methodologies, and more particularly to a system and a method of training individuals for enhanced skill acquisition and performance improvement through empathetic decision-making instructional exercises i.e., real project-based scenario exercises.

### BACKGROUND

The success of any organization is inextricably linked to the capabilities and effectiveness of its workforce. In today's rapidly evolving landscape, it is more crucial than ever to equip professionals with the necessary skills and knowledge to adapt, innovate, and excel. However, the transition from theoretical learning to competent practice in professional roles can be fraught with challenges. To overcome these challenges, some traditional training methods are introduced.

Traditional training methods, such as lectures, textbooks, and case studies, have served as the cornerstone of professional development for decades. Undeniably, they offer a predictable and consistent learning experience for large groups, with minimal resource requirements. Available in various formats, from online courses to physical textbooks, they provide a strong foundation of theoretical knowledge and principles.

However, traditional methods also have significant limitations. They often lack interactivity and engagement, leading to passive learning and poor knowledge retention. The theoretical knowledge may not translate effectively to real-world situations, hindering skill development. They often use a one-size-fits-all approach, failing to cater to individual learning styles and preferences. They may focus on rote memorization and regurgitation of facts, neglecting critical thinking and problem-solving skills.

Additionally, in traditional training methods, course materials may contain questions that require learners to select the correct answer from a list of multiple options. During the course of the training, learners may encounter inflection points at which they are required to answer multiple-choice questions as they progress through the material. At each inflection point, learners are presented with a question and four possible answers, from which they must choose the correct option before proceeding to the next stage of the training. This approach may not provide an authentic and realistic experience for the learners, as in real work situations learners are never presented with a question and multiple possible answers. When it's time to make a decision, they have to decide on their own what decision they should make.

Recognizing these limitations, various existing training methods have emerged to bridge the gap between theory and practice. On-the-job training (OJT) provides hands-on experience in real-world settings, enhancing skill transferability and critical thinking. Fictitious scenario-based exercises, role-playing and simulations offer immersive experiences for practicing decision-making and navigating complex scenarios. Mentorship and coaching facilitate personalized guidance and feedback, catering to individual needs and learning styles. Interactive e-learning enhances engagement through gamified elements, quizzes, and collaborative activities.

However, these methods also have their limitations. OJT can be resource-intensive and time-consuming, dependent on mentor availability and experience. Fictitious scenario-based exercises, simulations and role-playing may lack realism and require significant development costs. Mentorship relies on finding suitable mentors and ensuring consistent quality of guidance. Interactive e-learning can be susceptible to distractions and require strong self-motivation for effective learning.

Therefore, there is a need for a system that trains individuals for enhanced skill acquisition and performance improvement through empathetic decision-making instructional exercises. There is also a need for a system that utilizes actual data and events to create authentic training exercises, boosting transferability and realism. Further, there is a need for a system that trains individuals to navigate both solo and collaborative decision-making situations, thereby facilitating the individuals to understand the impact of their decisions on larger systems and how strong processes mitigate risks.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a decision-making instructional process (DMIP), which is a training method for training individuals to develop profession-relevant skills and knowledge. The method comprises the steps include at one step, an expert could create one or more course materials with one or more scenarios as decision-making instructional exercises in a work role using available data of at least one completed project, thereby assisting learners in training and making decisions. The decision-making instructional exercises could be real project-based scenario exercises. At another step, the data of the at least one completed project is anonymized to mask the identity of the completed project to the learners, thereby enabling even a well-known project to become unrecognizable to the learners. The data of the at least one completed project includes, but not limited to, sensitive information, personal details, and project specifics. At another step, the expert may create instructional data for instructors to guide the learners for solving the decision-making instructional exercises in the work role.

At another step, the learners are then assigned with the at least one course material to train for the work role. At another step, the learners could identify information gaps in the one or more course materials, which allows the learners to make logical decisions and assumptions. At another step, the learners document their logics and reasoning behind assessments and decisions for retrospective comparison of the decision-making instructional exercises included in the course materials. At another step, the learners collaborate and respectfully argue their viewpoints on the respective decision-making instructional exercises to solve with each other in the presence of the instructor.

Further, at another step, the instructors could guide the learners in making the decisions according to the scenarios included the one or more course materials to solve the decision-making instructional exercises and creating a responsive learning environment where critical thinking is paramount to train the learners. The instructors could use the instructional data to train the learners.

In another embodiment of the invention, a system is configured for training the individuals or learners to develop profession-relevant skills and knowledge. In one embodiment herein, the system comprises a computing device having a processor and a memory in communication with the processor configured to store one or more instructions executable by the processor. The computing device is in communication with a server and one or more user devices via a network. The system is configured to create the course materials with scenarios as decision-making instructional exercises in a work role using available data of at least one completed project and anonymize the data of the at least one completed project to mask its identity to the learners, thereby enabling even a well-known project to become unrecognizable to the learners. The data of the at least one completed project includes, but not limited to, sensitive information, personal details, and project specifics, etc. The system is configured to create instructional data for the instructors to guide the learners for solving the decision-making instructional exercises in the work role.

The learners are assigned at least one course material by the system to train for the work role through the user device, for example, a smartphone. The learners could identify information gaps in the course materials, which allows them to make logical decisions and assumptions. The learners document their logics and reasoning behind assessments and decisions for retrospective comparison of the decision-making instructional exercises included in the course materials using the user device. The learners collaborate and respectfully argue their viewpoints on the respective decision-making instructional exercises to solve with each other in the presence of the instructor, who guides them in making decisions according to the scenarios included in the course materials.

In another embodiment of the invention, a non-transitory computer-readable storage medium stores a computer program that, when executed on a computer, enables the computer to perform the method applied to an electronic device comprising a touch display screen. The method comprises creating decision-making instructional exercises in a work role using available data of at least one completed project, and anonymizing the data of the at least one completed project to mask its identity to the learners, thereby enabling even a well-known project to become unrecognizable to the learners. The data of the at least one completed project includes sensitive information, personal details, and project specifics. The method further comprises a step of creating instructional data for instructors to guide the learners for solving the decision-making instructional exercises in the work role.

The learners are then assigned at least one course material to train for the work role, and they identify information gaps in the course materials, which allows them to make logical decisions and assumptions. The learners document their logics and reasoning behind assessments and decisions for retrospective comparison of the decision-making instructional exercises included in the course materials. The learners collaborate and respectfully argue their viewpoints on the respective decision-making instructional exercises to solve with each other in the presence of the instructor.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a flowchart of a method of training individuals to develop profession-relevant skills and knowledge, in accordance with embodiments of the invention.

FIG. 2 illustrates a block diagram of a system for training individuals to develop profession-relevant skills and knowledge, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

According to an exemplary embodiment, the invention discloses a decision-making instructional process (DMIP), a training method that leverages valuable insights gained from prior experiences to convert professional training into an engaging and rewarding expedition. Rather than relying on theoretical frameworks and textbook illustrations, trainees or learners are immersed in simulated situations that are derived from actual work projects. This immersive approach cultivates the acquisition of skills and knowledge that are pertinent to the profession and can be directly applied to real-world situations.

In one embodiment herein, DMIP may be delivered offline to the learners through printed exercises. The learners might be trainees, individuals, employees, managers and executives. DMIP aims to provide structured decision-making instructional exercises that are tailored to real-life successes and failures associated with a particular work role. The decision-making instructional exercises could be real project-based scenario exercises. DMIP is designed to closely mimic historical examples, thereby reducing the burden of on-the-job training and providing detailed insight into human decision-making processes. This approach is applicable to a vast majority of work roles that require employee training, particularly prior to onboarding. This innovative training method can be utilized to create instructional material for various professions in governments, corporations, and universities, catering to learners at all levels, including decision-makers and supporting roles, especially when critical thinking is paramount.

In one embodiment herein, DMIP commences by selecting a training session that entails the customer's active participation in furnishing intricate particulars of their prior projects, which could be potentially transformed into decision-making instructional exercises. The chosen project ought to possess a balance of complexity and simplicity, with numerous decision-making inflection points. The project should neither be too protracted, leading to disinterest amongst the learners, nor too brief, depriving them of decision-making opportunities. Additionally, the project should not be so prevalent that it remains recognizable, even after substituting all proper nouns with fictitious ones.

The scenarios are built upon real-life completed projects to provide valuable insights and practical challenges directly applicable to the work roles. The proper nouns such real names, locations, directions, landmarks, and other identifying details in the course materials are replaced with fictional nouns, thereby ensuring the scenarios remain realistic while protecting sensitive information of the completed project and completely undetectable to the learners. This way, the learners will not be able to easily search or trace the course materials and results of the scenarios through online search engines such as Google and Bing.

If the completed project, which the decision-making instructional exercise is based on, is recognizable or traceable by the learners, they would be aware of the outcome of the project, and the decision-making instructional exercise would lose its effectiveness. This would also create a hierarchy in the class because the experienced learners would have an unfair advantage due to having more knowledge of the completed project. If the completed project and results of the scenarios are traceable, then the learners who traced them would speak with more authority and may be able to patronize those who have not worked on the project themselves. However, the method of training individuals should provide equal weightage to all learners and treat them as equals because none of them knows which project it is.

In one embodiment herein, instructional data is created for instructors to guide the learners for solving the decision-making instructional exercises for the work role. The instructional data includes questions, disagreements, and alternative situations, solutions and decisions related to the respective decision-making instructional exercises. The instructional data is updated periodically with more potential questions by the experts. This methodology could be used in various fields including engineering, medicine, law, military, management, law enforcement, aviation, journalism and thereof.

The training program entails providing learners with customized scenarios and relevant materials that align with their designated work roles and the decision-making instructional exercises. Individually, the learners or the individuals may analyze the materials to identify critical information gaps that pertain to their role and preferred course of action or conclusion. By identifying the information gaps, the learners are allowed to reach the experts or instructors to communicate and look for additional data that is not disclosed in the one or more course materials, encouraging even the most introverted learners to get out of their shells and ask questions. The social and collaborative aspect of the decision-making and problem-solving technique is a crucial component of the training.

The learners collaborate and respectfully argue their viewpoints on the respective decision-making instructional exercises to solve with each other in the presence of the instructor. The instructor may provide guidance to the learners in making the final decision on the group's course of action or conclusion, taking into account the internal dynamics of the organization being simulated. The instructor is well-versed in the decision-making instructional exercise's conditions and constraints, which allows for maximum flexibility to respond to learners' decisions and create a dynamic learning environment. Eventually, real-world decisions are revealed for the scenarios and compared to the learner's decisions, thereby providing a feedback that highlights areas of strength and potential improvement.

The decision-making instructional exercises i.e., real project-based scenario exercises transport the learners into a simulated work environment, recreating the daily challenges and decisions they'd face in their actual job roles. It's not just about completing tasks; it's about experiencing the difficulties of real-world work, including the resourcefulness and collaboration needed to navigate the complex situations. The learners may also have access to contact support networks available in their work roles. This allows the learners to communicate with the seniors or experts who can offer guidance, answer questions, and provide valuable insights just like colleagues, managers, or other relevant contacts. This collaborative learning approach encourages the learners to seek assistance when needed, fostering communication, resourcefulness, and problem-solving skills. The instructor may facilitate that expert who they're trying to reach out to. This is another valuable aspect of these decision-making instructional exercises, as it gives them an opportunity to seek information from others instead of getting stuck and wasting time without knowing what to do.

Furthermore, the training method serves as a cost-effective and time-efficient approach, rendering it particularly valuable for employee training, especially prior to onboarding. Subject matter experts play a pivotal role in creating course material and delivering the training, thereby expediting the development process and contributing to cost reduction. This methodology is versatile and can be seamlessly applied across different work roles in multiple fields include engineering, medicine, law, military, management, law enforcement, aviation, and journalism, etc. During the decision-making instructional exercises, the learners are presented with decisions akin to those they would encounter in their actual job roles, with instructor guidance available in the event of an incorrect decision. Instructors are equipped to guide the learners based on real-world information collected during the development phase.

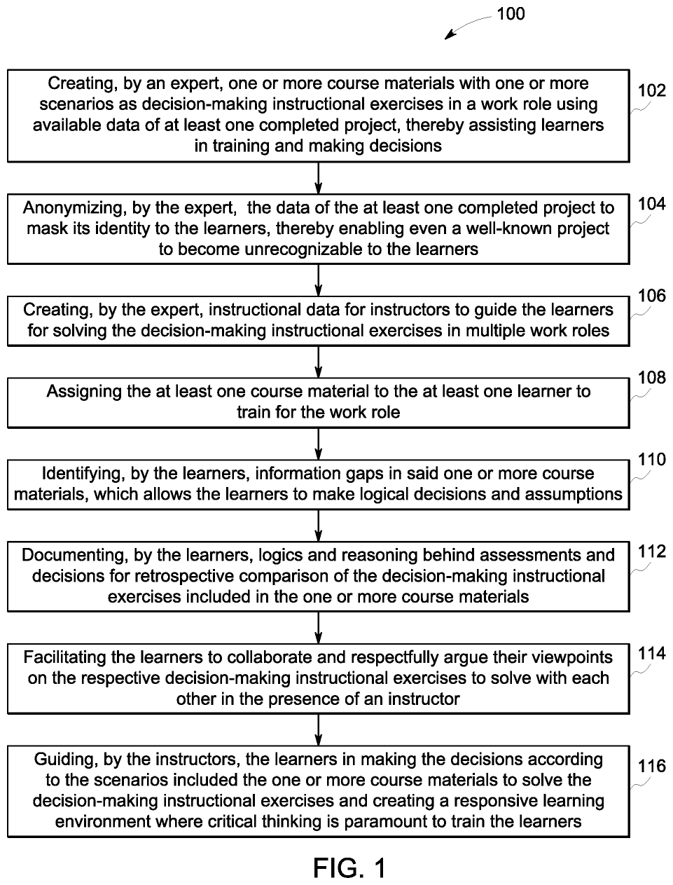

FIG. 1 refers to a flowchart 100 of a method of training the individuals to develop profession-relevant skills and knowledge. In one embodiment herein, the method comprises the steps of: at step 102, the expert creates one or more course materials with one or more scenarios as decision-making instructional exercises in the work role using available data of at least one completed project, thereby assisting the learners in training and making decisions. In one embodiment, the expert could create at least one course material with the one or more scenarios for a specific work role, for example, a medical field at one time and it can also be applicable to other work roles in different fields. This course material can be designed to impart knowledge and decision-making skills to the learners about a specific aspect of the work role and also across multiple work roles in the different fields.

When creating the material for the decision-making instructional exercises i.e., real project-based scenario exercises, the experts must think of challenging decision-making instructional exercises to add for the learners. The learners will then work on the tasks, gather the required information, and complete the tasks as a team or individually. It adds richness and develops critical thinking skills to the learners while solving the decision-making instructional exercises.

At step 104, the data of the at least one completed project is anonymized by the expert to mask its identity to the learners, thereby enabling even a well-known project to become unrecognizable to the learners. In one embodiment herein, the data of the at least one completed project includes, but not limited to, sensitive information, personal details, and project specifics, etc. The anonymization process in this training method also ensures that all the learners start the decision-making instructional exercises having the same level of knowledge. The knowledge provided within each scenario mirrors the exact information initially available to the actual team involved in the real-life project the scenario is based on. This approach levels the playing field, allowing junior learners to focus on developing critical thinking and decision-making skills without being disadvantaged by their lack of prior experience. By replicating the actual team's knowledge, the training emphasizes the importance of utilizing available information effectively and collaboratively, promoting a fair and enriching learning experience for all involved.

At step 106, instructional data is created for instructors to guide the learners for solving the decision-making instructional exercises in the work role. At step 108, the at least one course material is assigned to the at least one learner to train for the work role. When the at least one course material is assigned to the at least one learner, the instructor will provide instructions and all the required information related to the course material and the decision-making instructional exercises included in the course material in a work role. This prevents the learners from deviating from the assigned tasks to complete the decision-making instructional exercises. The learners begin with the same introductory knowledge given to the actual team at the project's start. This initial information outlines the project goals and parameters, much like a project brief. This approach fosters critical thinking, strategic planning, and decision-making skills in an environment that closely resembles real-world project dynamics.

At step 110, the learners identify the information gaps in the one or more course materials, which allow the learners to make logical decisions and assumptions. At step 112, the learners may record logics and reasoning behind assessments and decisions for retrospective comparison of the decision-making instructional exercises included in the one or more course materials. At step 114, the learners collaborate with each other and respectfully argue their viewpoints on the respective decision-making instructional exercises to solve as a group in the presence of the instructor. Further, at step 116, the instructor guides the learners in making the decisions according to the scenarios included in the one or more course materials to solve the decision-making instructional exercises and creating a responsive learning environment where critical thinking is paramount to train the learners. This approach effectively transforms the completed projects into adaptable decision-making instructional exercises with one or more scenarios, which makes the method cost-effective and widely applicable across various work roles.

The instructor does not interfere with the decisions made by the learners while they are solving the decision-making instructional exercises i.e., real project-based scenario exercises. However, the instructor may intervene if they detect that the learners are going off track or down a rabbit hole. Otherwise, the instructor may listen to and observe the discussions of the learners, thereby making the course student-driven rather than teacher-driven. This approach allows for greater engagement and critical thinking on the part of the learners.

The present training method approach differs from the existing techniques as the present training method harnesses the inherent challenge of real-life completed projects. Instead of fabricated situations, the learners face actual tasks, challenges and decisions faced by professionals in their field. The anonymized scenarios present the same uncertainties, complexities, and information gaps present in the real projects. There are no pre-set inflection points or forced decisions, so that the learners may navigate freely to uncover information and make choices as they would in the real project.

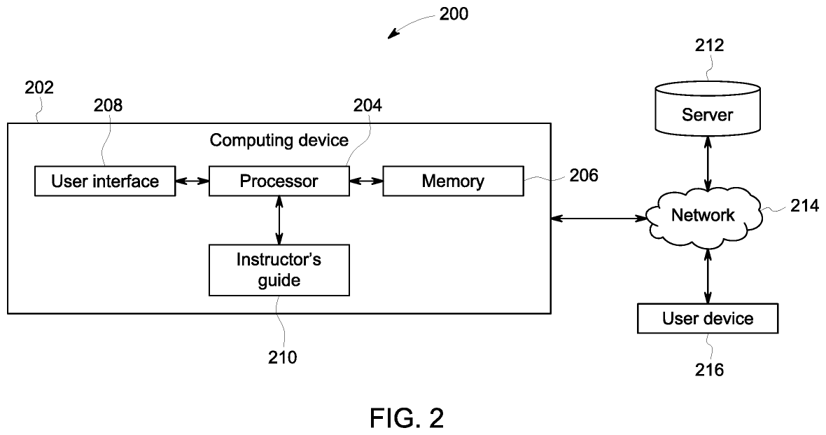

According to another exemplary embodiment of the invention, FIG. 2 refers to a block diagram of a system 200 for training individuals to develop profession-relevant skills and knowledge. In one embodiment herein, the system 200 facilitates the development of profession-specific skills and knowledge in the learners through the utilization of the decision-making instructional exercises. The system 200 comprises a computing device 202 having a processor 204 and a memory 206 in communication with the processor 204. The memory 206 is configured to store one or more instructions executable by the processor 204. When executed by the processor 204, the one or more instructions cause the system to create one or more course materials with scenarios as the decision-making instructional exercises in a work role by the processor 204 using available data of at least one completed project, thereby assisting learners in training and making decisions.

In one embodiment, the system 200 could create at least one course material with the one or more scenarios for a specific work role, for example, a medical field at one time and it can also be applicable to other work roles in the different fields. This course material can be designed to impart knowledge and decision-making skills to the learners about a specific aspect of the work role and also across multiple work roles in the different fields.

In one embodiment herein, the processor 204 could anonymize the data of at least one completed project to mask its identity to the learners, thereby enabling even a well-known project to become unrecognizable to the learners. The data of at least one completed project includes, but is not limited to, sensitive information, personal details, and project specifics, etc. The anonymization process includes adding of fictitious information to the one or more course materials while creating the one or more course materials, thereby encouraging creative thinking and problem-solving skills among the learners. The processor 204 creates instructional data for instructors to guide the learners for solving the decision-making instructional exercises in the work role. In one embodiment herein, the instructional data includes, but not limited to, questions, disagreements, and alternative situations, solutions and decisions related to the respective decision-making instructional exercises. The system 200 is configured to update instructional data periodically with more potential questions.

In one embodiment herein, the processor 204 assigns at least one course material to the at least one learner to train for the work role through a user device 216. The learners identify information gaps in the one or more course materials, which allows the learners to make logical decisions and assumptions. The learners facilitate to record logics and reasoning behind assessments and decisions for retrospective comparison of the decision-making instructional exercises included in the one or more course materials. The processor 204 enables the learners to collaborate and respectfully argue their viewpoints on the respective decision-making instructional exercises to solve with each other in the presence of the instructor through the user devices 216.

In one embodiment herein, the processor 204 is configured to allow the instructors to guide the learners in making the decisions according to the scenarios included the one or more course materials to solve the decision-making instructional exercises and creating a responsive learning environment where critical thinking is paramount to train the learners.

In one embodiment herein, the system 200 is configured to select the completed projects based on one or more parameters include, but not limited to, decisions made in the completed projects, the impact of those decisions on the final outcome, complexity, length and popularity of the completed projects, etc. The one or more course materials are created by the system 200 with inadequate information, which allows the learners to reach experts or instructors to communicate and look for additional data that is not disclosed in the one or more course materials.

In one embodiment herein, the system 200 is accessible through a variety of platforms includes at least one of, but not limited to, web browsers, video games, and virtual reality environments, etc. The system 200 is applicable for different work roles in the multiple fields include, but not limited to, engineering, medicine, law, military, management, law enforcement, aviation, journalism and thereof. In one embodiment herein, the system 200 may use an artificial intelligence (AI) model to expedite the development of the one or more course materials with the scenarios as decision-making instructional exercises. The AI model could generate the decision-making instructional exercises for use in the course materials. This approach can be particularly useful in the development of the decision-making instructional exercises i.e., real project-based scenario exercises, which are often time-consuming to create manually.

With the help of the AI model, multiple scenarios can be generated quickly and efficiently, thereby reducing the time and cost. The system 200 could make it easier for institutions, trainers, and other course developers to create high-quality course materials for the learners. This can help to improve overall learning outcomes, making it easier for the learners to acquire new knowledge and decision-making skills. Additionally, by reducing the time and cost associated with course material development, the system 200 could make it easier for organizations to deliver training more efficiently.

In one embodiment herein, the computing device 202 and the user device 216 are used generally herein to refer to any computing device configured to perform operations of the various embodiments, including one or all of personal computers, cellular telephones, smart phones, personal data assistants (PDA's) laptop computers, tablet computers, smart books, palm-top computers, wireless electronic mail receivers, multimedia Internet enabled cellular telephones, and similar personal electronic devices.

In one embodiment herein, the computing device 202 comprises a user interface 208 configured to present the scenario and relevant materials to the individuals. The user interface 208 is also configured to facilitate the individuals' analysis, decision-making, and collaboration. The user interface 208 is also configured to display the real-world decisions and the individuals' decisions. The user interface 208 also provides feedback and performance evaluation results. The computing device 202 further comprises an instructor's guide 210 that contains detailed information about the selected project and the scenario creation process, guidelines for facilitating individual and group activities within the scenario, potential information gaps and alternative branches to be prepared, and discussion prompts and additional resources to enhance learning outcomes. In one embodiment herein, the user interface 208 is at least one of a display unit, a touchscreen, a screen with control buttons, etc. through which the user interacts to communicate with the computing device 202 for controlling or performing the operations.

In one embodiment herein, the computing device 202 is in communication with a server 212 via a network 214. The server 212 can be a library of pre-designed scenarios for various professions and skillsets. The server 212 stores information about past projects and their associated decisions. The server 212 also stores performance evaluation data from previous users of the system 200. In one embodiment herein, the computing device 202 is in communication with the one or more user devices 216 via the network 214.

In another embodiment herein, the network 214 could be, but is not limited to, Wi-Fi, Bluetooth, a wireless local area network (WLAN)/Internet connection, and radio communication. In some embodiments, the computing device 202 could be a touchscreen and/or a non-touchscreen and adopted to run on any type of OS, such as iOS, Windows, Android, Unix, Linux and/or others. In an embodiment herein, the server 212 is at least one of a general or special purpose computer or a server. The server 212 could be operated as a single computer, which can be a hardware and/or software server, a workstation, a desktop, a laptop, a tablet, a mobile phone, a mainframe, a supercomputer, a server farm, and so forth.

Another exemplary embodiment of the invention involves a non-transitory computer-readable storage medium that stores a computer program, which, when executed on a computer, enables the computer to perform a training method on an electronic device equipped with a touch display screen. The training method includes several steps. First, the processor creates one or more course materials with the one or more decision-making instructional exercises in a work role using available data from at least one completed project to assist learners in training and decision-making. Next, the processor anonymizes the data of the at least one completed project to mask its identity to the learners, thereby enabling even a well-known project to become unrecognizable to the learners. The data of the at least one completed project includes, but not limited to, sensitive information, personal details, and project specifics. Instructional data is then created for instructors to guide learners in solving the decision-making instructional exercises in the work role.

Subsequently, at least one course material is assigned to at least one learner to train for the work role through the user device. Learners identify information gaps in the course materials that allow them to make logical decisions and assumptions. Learners are then facilitated to record logics and reasoning behind assessments and decisions for retrospective comparison of the decision-making instructional exercises included in the course materials. The processor enables learners to collaborate and respectfully argue their viewpoints on the respective decision-making instructional exercises in the work role to solve with each other in the presence of the instructor through the user devices.

Furthermore, the processor facilitates instructors to guide learners in making decisions according to the scenarios included in the course materials to solve the decision-making instructional exercises and create a responsive learning environment where critical thinking is paramount to train the learners. The processor also reveals real-world decisions for the scenarios and compares them to the learner's decisions, thereby providing feedback that highlights areas of strength and potential improvement.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A method of training individuals to develop profession-relevant skills and knowledge, comprising:
creating, by an expert, one or more course materials with one or more scenarios as decision-making instructional exercises in a work role using available data of at least one completed project, thereby assisting learners in training and making decisions;
anonymizing, by the expert, the data of the at least one completed project to mask its identity to the learners, thereby enabling even a well-known project to become unrecognizable to the learners;
creating, by the expert, instructional data for instructors to guide the learners for solving the decision-making instructional exercises in the work role;
assigning the at least one course material to the at least one learner to train for the work role;
identifying, by the learners, information gaps in said one or more course materials, which allows the learners to make logical decisions and assumptions;
documenting, by the learners, logics and reasoning behind assessments and decisions for retrospective comparison of the decision-making instructional exercises included in the one or more course materials;
facilitating the learners to collaborate and respectfully argue their viewpoints on the respective decision-making instructional exercises to solve with each other in the presence of the instructor; and
guiding, by the instructors, the learners in making the decisions according to the scenarios included the one or more course materials to solve the decision-making instructional exercises and creating a responsive learning environment where critical thinking is paramount to train the learners.

2. The method of claim 1, wherein real-world decisions are revealed for the scenarios and comparing them to the learner's decisions, thereby providing a feedback that highlights areas of strength and potential improvement.

3. The method of claim 1, wherein the data of the at least one completed project includes sensitive information, personal details, and project specifics.

4. The method of claim 1, wherein the one or more course materials are created with inadequate information, which allows the learners to reach experts or instructors to communicate and look for additional data that is not disclosed in the one or more course materials.

5. The method of claim 1, wherein the completed projects are selected based on one or more parameters such as decisions made in the completed projects, the impact of those decisions on the final outcome, complexity, length and popularity of the completed projects.

6. The method of claim 1, wherein the experts increase difficulty levels of the decision-making instructional exercises and challenges in a crawl run mode in terms of length, permissible completion time, and number of storylines.

7. The method of claim 1, wherein the instructional data includes questions, disagreements, and alternative situations, solutions and decisions related to the respective decision-making instructional exercises.

8. The method of claim 1, wherein the instructional data is updated periodically with more potential questions by the experts.

9. The method of claim 1, wherein the work roles in multiple fields include engineering, medicine, law, military, management, law enforcement, aviation, journalism and thereof.

10. A system for training individuals to develop profession-relevant skills and knowledge, comprising:
a computing device having a processor and a memory in communication with said processor configured to store one or more instructions executable by said processor,
wherein said computing device is in communication with a server and one or more user devices via a network,
wherein when executed by said processor, said one or more instructions cause the system to:
create, by said processor, one or more course materials with one or more scenarios as decision-making instructional exercises in a work role using available data of at least one completed project, thereby assisting learners in training and making decisions;
anonymize the data of the at least one completed project to mask its identity to the learners, thereby enabling even a well-known project to become unrecognizable to the learners, wherein the data of the at least one completed project includes sensitive information, personal details, and project specifics;
create instructional data for instructors to guide the learners for solving the decision-making instructional exercises in the work role;
assign the at least one course material to the at least one learner to train for the work role through a user device;
identify, by the learners, information gaps in said one or more course materials, which allows the learners to make logical decisions and assumptions;
facilitate the learners to record logics and reasoning behind assessments and decisions for retrospective comparison of the decision-making instructional exercises included in the one or more course materials; and
enable to the learners to collaborate and respectfully argue their viewpoints on the respective decision-making instructional exercises to solve with each other in the presence of the instructor through the user devices.

11. The system of claim 10, wherein the processor is configured to allow the instructors to guide the learners in making the decisions according to the scenarios included the one or more course materials to solve the decision-making instructional exercises and creating a responsive learning environment where critical thinking is paramount to train the learners.

12. The method of claim 10, wherein the processor is configured to reveal real-world decisions for the scenarios and comparing them to the learner's decisions, thereby providing a feedback that highlights areas of strength and potential improvement.

13. The system of claim 10, wherein the one or more course materials are created by the system with inadequate information, which allows the learners to reach experts or instructors to communicate and look for additional data that is not disclosed in the one or more course materials.

14. The system of claim 10, wherein the system is configured to select the completed projects based on one or more parameters include decisions made in the completed projects, the impact of those decisions on the final outcome, complexity, length and popularity of the completed projects.

15. The system of claim 10, wherein the system is configured to increase difficulty levels of the decision-making instructional exercises and challenges in a crawl run mode in terms of length, permissible completion time, and number of storylines.

16. The system of claim 10, wherein the instructional data includes questions, disagreements, and alternative situations, solutions and decisions related to the respective decision-making instructional exercises.

17. The system of claim 10, wherein the system is configured to update instructional data periodically with more potential questions.

18. The system of claim 10, wherein the system is accessible through a variety of platforms includes web browsers, video games, and virtual reality environments.

19. The system of claim 10, wherein the work roles in multiple fields include engineering, medicine, law, military, management, law enforcement, aviation, journalism and thereof.

20. A non-transitory computer-readable storage medium storing a computer program, wherein when the computer program is executed on a computer, the computer is enabled to perform a training method applied to an electronic device comprising a touch display screen, and the method comprises:
creating, by said processor, one or more course materials with one or more scenarios as decision-making instructional exercises in a work role using available data of at least one completed project, thereby assisting learners in training and making decisions;
anonymizing the data of the at least one completed project to mask its identity to the learners, thereby enabling even a well-known project to become unrecognizable to the learners, wherein the data of the at least one completed project includes sensitive information, personal details, and project specifics;
creating instructional data for instructors to guide the learners for solving the decision-making instructional exercises in the work role;
assigning the at least one course material to the at least one learner to train for the work role through a user device;
identifying, by the learners, information gaps in said one or more course materials, which allows the learners to make logical decisions and assumptions;
facilitating the learners to record logics and reasoning behind assessments and decisions for retrospective comparison of the decision-making instructional exercises included in the one or more course materials;
enabling to the learners to collaborate and respectfully argue their viewpoints on the respective decision-making instructional exercises to solve with each other in the presence of the instructor through the user devices;
facilitating the instructors to guide the learners in making the decisions according to the scenarios included the one or more course materials to solve the decision-making instructional exercises and creating a responsive learning environment where critical thinking is paramount to train the learners; and
revealing real-world decisions for the scenarios and comparing them to the learner's decisions, thereby providing a feedback that highlights areas of strength and potential improvement.
